(19) United States
(12) Patent Application Publication
(10) Pub. No.: US 2024/0125236 A1
(43) Pub. Date: Apr. 18, 2024

(54) SYSTEM FOR IN-SITU SURFACE PROCESSING OF AN ENGINE BLADE

(71) Applicant: Richard Wolf GmbH, Knittlingen (DE)

(72) Inventors: Daniel SCHWAB, Knittlingen-Freudenstein (DE); Oktay HALMAN, Munchen (DE)

(21) Appl. No.: 18/485,410

(22) Filed: Oct. 12, 2023

(30) Foreign Application Priority Data
Oct. 13, 2022 (DE) 20 2022 105 802.4

(51) Int. Cl. F01D 5/00; B24B 19/14; B24B 27/027

(52) U.S. Cl. CPC F01D 5/005; B24B 19/14; B24B 27/027; F05D 2230/80

(57) ABSTRACT

A system provides in-situ surface processing of an engine blade within an aircraft engine. The system includes an endoscopic processing instrument with a variable-angle tubular shaft. The processing instrument is inserted radially through a lateral access opening into the aircraft engine in a non-angled initial configuration. The lateral access opening is downstream of the engine blade. The processing instrument has a rotatably driven tool holder at a distal end of the shaft for a surface processing tool head. In an angled working configuration, a tool head inserted into the tool holder is applied to a flow edge of the engine blade. Furthermore, a process uses the corresponding system.

### CROSS REFERENCE TO RELATED APPLICATIONS

This application claims the benefit of priority under 35 U.S.C. § 119 of German Application 20 2022 105 802.4, filed Oct. 13, 2022, the entire contents of which are incorporated herein by reference.

### TECHNICAL FIELD

The present invention relates to a system for in-situ surface processing of an engine blade within an aircraft engine extending along a main fluid flow direction from a fluid inlet side to a fluid outlet side, wherein the system comprises an endoscopic processing instrument with a tubular shaft that can be angled, wherein the processing instrument is set up such that it can be inserted essentially radially through at least one lateral access port into the aircraft engine in a non-angled initial configuration. Furthermore, the present invention relates to the use of such a system for the surface treatment of an engine blade.

### BACKGROUND

Modern aircraft engines have a plurality of compressor and turbine stages. Each of the compressor and turbine stages comprises a plurality of engine blades that are arranged in the engine such that they can rotate. The engine blades are also referred to as rotor blades. In the course of operation, minor damage and cracks can occur at the leading edges and trailing edges of the engine blades, which are collectively referred to as the flow edges.

In order to be able to repair such damage without having to disassemble the entire engine casing, it is of known art to use endoscopic systems, and to insert them into the aircraft engine through lateral access ports provided in the engine casing. Various tools can be deployed on the head of the endoscopic processing devices or processing instruments, with which the damage is first blended out, and then polished.

In order to be able to work on the engine blades of all compressor and turbine stages, the engine casings have at least one access port for each compressor and turbine stage, which is arranged ahead, that is to say upstream, of the respective compressor or turbine stage, and thus of the engine blades to be repaired. The lateral access port is thus arranged between the fluid inlet side of the aircraft engine and the respective engine blade to be repaired.

However, by virtue of the increasingly complex geometry of aircraft turbine blades, the leading edges, and especially the trailing edges, of the blades can no longer be reached reliably, or at all, in this way. This makes it difficult to repair the corresponding regions of the rotor blades using the methods of known art.

### SUMMARY

Against this background, the person skilled in the art is faced with the task of providing an improved system for the in-situ surface processing of an engine blade.

The problem underlying the invention is solved by a system with features according to this disclosure as well as a process using such a system. Preferred embodiments of the system and the process of use thereof are specified herein.

To solve the problem, in a first aspect a system is proposed for in-situ surface processing of an engine blade within an aircraft engine extending along a main fluid flow direction from a fluid inlet side to a fluid outlet side. The system has an endoscopic processing instrument with a tubular shaft that can be angled. The processing instrument is set up so as to be inserted into the aircraft engine in a non-angled initial configuration, essentially radially through at least one lateral access port. The lateral access port is arranged downstream of the engine blade. In a distal end of the shaft the processing instrument has a rotatably driven tool holder for a tool head for the surface processing, and is configured with an angled working configuration such that a tool head inserted into the tool holder engages with a flow edge of the engine blade.

In other words, a system is provided with which the surfaces of engine blades and, in particular, the leading edges and trailing edges of the latter in a turbine, can be processed without having to disassemble the turbine for this purpose, that is to say, without having to remove the engine casing, for example. The system comprises an endoscopic processing instrument with a tubular shaft that can be angled. Here the term “angled” is to be understood to mean that different sections of the shaft can be arranged at at least two different angles relative to each other.

In a first, non-angled state, referred to as the initial configuration, the processing instrument can be inserted into the aircraft engine through an access port. This access port can, for example, be formed laterally in the engine casing. The processing instrument is at least partially inserted, that is to say, introduced, through the access port into the interior of the engine; this essentially corresponds to a radial movement towards the central axis of the engine.

Here the processing instrument is configured such that it is not inserted through an access port located upstream in the main flow direction of the engine blade to be processed, but through an access port that is located on the downstream side of the engine blade in terms of flow direction. The engine blade is thus arranged between the access port and the fluid inlet side of the aircraft engine.

The processing instrument furthermore has a tool holder at its distal or free end of the shaft, into which a tool head can be inserted for purposes of surface processing. The tool holder, and with it also the tool head, are rotatably driven, wherein preferred configurations of the drive are described in the context of preferred forms of embodiment.

In overall terms the processing instrument is configured, in the working configuration, in which the shaft is angled with respect to the initial configuration, with a tool head inserted into the tool holder, for example, so as to engage with and process a leading edge or trailing edge of an engine blade.

The system thus enables the surface processing of engine blades with complex geometries that cannot be reached, or cannot be completely reached, by conventional processing instruments located upstream of the engine blade in the flow direction. Here, access ports are used that are actually intended for compressor and turbine stages located downstream of the engine blade that is to be processed. The distance between the access ports and the respective engine blades can be a number of centimeters in the flow direction, for example 7 cm. This distance can be covered by the appropriately configured processing instrument that is part of the present system, so that it is also possible to machine surfaces that are too far away from the access port when using conventional tools.

In a preferred form of embodiment, an observation instrument is integrated into the processing instrument. Such an observation instrument can be implemented, for example, in terms of a mirror arrangement that enables a user or operator of the system to look through the access port through which the processing instrument is inserted into the interior of the engine.

In an alternative form of embodiment, the system comprises an endoscopic observation instrument that is separate from the processing instrument. The observation instrument is set up so as to be inserted essentially radially through another lateral access port of the aircraft engine, wherein the other lateral access port is located upstream of the engine blade. Thus, in the preferred form of embodiment, for example, the access port that is actually provided for the processing of the engine blade, and that is located between the engine blade and the fluid inlet side of the aircraft engine, can be used for the insertion of an endoscopic observation instrument. Through this access port, an engine blade can then be examined and observed while it is being processed by the tool inserted through the access port downstream in the flow direction.

In a preferred form of embodiment, the shaft of the processing instrument has a proximal first shaft section and a distal second shaft section. The second shaft section is angled with respect to the first shaft section for purposes of changing from the initial configuration to the working configuration. A tool head inserted into the tool holder extends from a free distal end of the second shaft section. A drive shaft for the tool holder is mounted such that it can rotate within the second shaft section. The drive shaft can be used to drive a tool head inserted into the tool holder.

In the preferred form of embodiment, the processing instrument is provided with a shaft that has at least a first shaft section and a second shaft section. The first, or proximal, shaft section is closer to the operator of the processing instrument than the second, or distal, shaft section, which is arranged further away from the operator. To move the processing instrument from the initial configuration, in which it is inserted into the engine through the access port, to the working configuration, in which the engine blades can be processed, the second shaft section is angled relative to the first shaft section. In the initial configuration, the second shaft section is preferably arranged as an extension of the first shaft section. The tool holder is part of the second shaft section, and is arranged in the latter such that a tool head inserted into the tool holder protrudes from a free end of the second shaft section.

In order to process the surfaces of the engine blades with the tool head, the latter must rotate. In order to drive or rotate the tool holder, therefore, a drive shaft is provided that is mounted or arranged such that it can rotate within the second shaft section. For example, a drive shaft can be arranged such that it can rotate within a shaft section in which it is partially or completely surrounded by a sleeve or tube. There is thus a non-rotating part of the second shaft section, which at least partially or preferably completely encloses the drive shaft, and thus prevents any inadvertent damage within the engine caused by the rotating drive shaft, should the second shaft section, other than the tool head, come into contact with the engine blade or another component of the engine while the drive shaft is rotating.

The second shaft section preferably has a length that is at least five times greater than an outer diameter of the first shaft section.

In order to drive the drive shaft, a drive belt running along the first shaft section is preferably provided, which belt, in the working configuration, runs around a proximal end of the drive shaft that serves as a belt guide pulley. The drive shaft arranged in the second shaft section is thus preferably rotated by means of a belt drive. The drive belt can in turn be driven, for example, by a motor, which is arranged, for example, in a handgrip, or a manipulation device to be held manually, which is provided. The belt drive is configured to run around a belt guide pulley forming the proximal end of the drive shaft, at least when the processing instrument is in the working configuration, that is to say, when the second shaft section is angled relative to the first shaft section. Thus, in the preferred form of embodiment, the end of the working shaft facing towards the first shaft section, or an operator is formed as a belt guide pulley, and is thus part of the belt drive used to drive the drive shaft, and thus a tool head inserted into the tool holder.

It is furthermore preferable for the drive belt to be tensioned by the angling of the second shaft section with respect to the first shaft section, from the initial configuration to the working configuration. It is thus envisaged that after the processing instrument has been inserted through the access port into, for example, an engine nacelle, the processing instrument is converted from the initial configuration to the working configuration. To do this, as explained earlier, the second shaft section is tilted relative to the first shaft section, so that it is angled relative to the latter. When the second shaft section is tilted or angled, according to the preferred form of embodiment, the drive that is guided around the belt guide pulley formed at the proximal end of the drive shaft is tensioned in the process. In this way, it is advantageously ensured that the drive shaft is only rotationally driven when the second shaft section is in the working configuration, and the processing of a surface is actually planned.

In a further preferred form of embodiment, the second shaft section comprises at least one coupling section and one extension section. The coupling section is joined to the first shaft section. The extension section is releasably connected to the coupling section. The extension section comprises a distal part of the drive shaft, together with a sleeve that surrounds the distal part of the drive shaft.

In other words, provision is preferably made for the second shaft section to have at least two sub-sections, which are referred to as the coupling section and the extension section. The part of the second shaft section that immediately adjoins the first shaft section is referred to as the coupling section. Part of this section could be, for example, the part of the drive shaft at the end of which the belt guide pulley for the drive belt is arranged, if the system has a drive belt.

The second part of the second shaft section is referred to as the extension section, which is releasably connected to the coupling section. In other words, the second section can be divided into at least two parts, the coupling section, and the extension section. Here, for example, the coupling section is fixedly connected to the first shaft section, but such that it can be angled, while the extension section is connected to the first shaft section via the coupling section.

The extension section comprises a second, distal part of the drive shaft and preferably also the tool holder. The distal part of the drive shaft is arranged in a sleeve which surrounds the drive shaft, and thus on the one hand protects the drive shaft from damage, but on the other hand also prevents any possible inadvertent damage caused by the rotating drive shaft. Finally, the tool holder can also be part of the extension section.

By the division of the second shaft section into a coupling section and an extension section, it is advantageously possible to use different extension sections, in particular, extension sections with different lengths. This enables the same processing instrument to be used for different distances between the access port and the surfaces that are to be processed. Here, only the extension section has to be replaced. A replacement of the entire processing instrument, however, is not necessary.

It is further preferred if the coupling section has an outboard coupling to connect the coupling section to the sleeve in a torque-proof manner, and an inboard coupling to connect the coupling section to the distal part of the drive shaft in a torque-proof manner. The inboard coupling can be rotated relative to the outboard coupling in order to drive the drive shaft. The connection between the outboard coupling and the sleeve and the inboard coupling and the drive shaft can be released.

In the preferred form of embodiment of the system, the coupling section has two couplings, an inboard coupling, and an outboard coupling. Both couplings are provided to establish torque-proof connections between the coupling section and various components or elements of the extension section. A connection is then torque-proof, for example, if two components that are connected to each other in a torque-proof manner cannot be rotated relative to each other. Thus, if the sleeve of the extension section is connected to the outboard coupling in a torque-proof manner, the sleeve cannot then be rotated relative to the outboard coupling. Similarly, the distal part of the drive shaft cannot rotate relative to the inboard coupling if the inboard coupling and the distal part of the drive shaft are connected in a torque-proof manner. If, accordingly, the inboard coupling is rotated, the distal part of the drive shaft also rotates.

However, it is envisaged that the inboard coupling can rotate with respect to the outboard coupling. The inboard coupling can thus be rotated relative to the outboard coupling so as to drive the distal part of the drive shaft. In this sense, the inboard coupling forms a section of the drive shaft that could also be referred to as the proximal section of the drive shaft. For example, a belt guide pulley can be formed at a proximal end of the inboard coupling if a drive belt extending along or within the first shaft section is to be used to drive the drive shaft.

In order to ensure that the extension section can be released from the coupling section, the connection between the outboard coupling and the sheath, together with the inboard coupling and the distal end of the drive shaft, can be released. This enables the extension section to be replaced.

In order to establish and release a connection between the extension section and the coupling section, the relative orientation between the sleeve and the distal part of the drive shaft is temporarily fixed. If the extension section is to be connected to, or disconnected from, the coupling section, the relative rotation between the sleeve that surrounds the distal part of the drive shaft, and the drive shaft is thus prevented.

In a preferred form of embodiment, the sleeve, and the distal section of the drive shaft each have a through-passage hole, with which the relative orientation of the sleeve and the distal section of the drive shaft can be fixed by aligning them relative to each other using a slit-shaped tool. The provision of a through-passage hole in the sleeve and distal part of the drive shaft enables the sleeve and drive shaft to be aligned easily relative to each other, and also secured against relative rotation with respect to each other, so that the extension section of the second shaft section can be connected to the coupling section. For example, the two sections can be screwed together, if the two coupling sections and the corresponding mating parts on the sleeve and the distal part of the drive shaft in each case have a thread, wherein, in a preferred exemplary form of embodiment, the pin-shaped tool also serves as a tool for purposes of screwing the extension section to the coupling section.

In a further preferred form of embodiment, the second shaft section has a proximal first sub-section and a distal second sub-section, wherein the second sub-section is at a fixed angle with respect to the first sub-section. A second shaft section can comprise a coupling section, an extension section and two sub-sections. However, it is also conceivable for the second shaft section to comprise only a first and a second sub-section. Thus, in any event, provision is made that in the preferred form of embodiment the second sub-section of the second shaft section is inclined relative to the first sub-section by a fixed angle. In other words, the second shaft section is not straight, but has a bend. This can be particularly advantageous if surfaces of an engine blade that are otherwise difficult to reach are to be processed.

Here it is preferable if the second sub-section is angled opposite to the first sub-section in the direction in which the second shaft section can be angled with respect to the first shaft section. In other words, the second sub-section is angled in the direction of an extension direction of the first shaft section with respect to the second shaft section.

It is furthermore preferable if the drive shaft extends in a bendable and/or articulated manner from the first sub-section into the second sub-section. For this purpose, the drive shaft can have at least one tubular transmission element. The design of the at least one tubular transmission element is slitted in at least one section. The slits thereby enable the tubular transmission element forming the drive shaft to be bent, and it can thus extend from the first into the second sub-section without the need for a further joint or any other form of coupling; this enables power transmission from the section of the drive shaft extending in the first sub-section to the section of the drive shaft that extends in the second sub-section.

It is furthermore preferable if the drive shaft comprises at least two nested tubular transmission elements, wherein each of the transmission elements is of slitted design in at least one overlapping section. By using two tubular transmission elements for the drive shaft in the region of the transition between the first and second sub-section, which are of slitted design in an overlapping section, the torque of the drive shaft can be transmitted particularly reliably from the first sub-section to the second sub-section. In particular, only minor torque losses occur.

It is particularly preferable if the at least one tubular transmission element is slit in the at least one section by means of a meandering multiple spiral-shaped peripheral laser cut. By virtue of the preferred use of a laser slit, the torque is transmitted with particularly low losses.

In a particularly preferred form of embodiment, the first sub-section and the second sub-section together form the extension section. Thus, the part of the drive shaft extending through the first sub-section and the second sub-section is the distal part of the drive shaft, and the first sub-section and the second sub-section are releasably connected to the coupling section. This has the particular advantage that the same processing tool can be used for surfaces of an engine blade that can be reached with different degrees of ease, since not only can straight extending second shaft sections or extension sections be used, but the use of extension sections that are bent or inclined is also expressly provided for.

In a preferred form of embodiment of the system, the processing instrument has a manipulation device to be held manually by an operator. A drive unit is integrated in the manipulation device, or can be connected to it. The shaft is releasably coupled to the manipulation device, but can also be non-releasably connected to the manipulation device.

Finally, a system is envisaged that additionally comprises a set of different tool heads that can be selectively coupled to the tool holder in a replaceable manner. Thus, the system can comprise not only one tool head, but a set of tool heads. For example, one tool head can be used for grinding, while a second tool head is used for polishing, and a third tool head is used for milling.

According to a second aspect, the problem underlying the invention is solved by using a system according to any of the preceding embodiments for in situ surface machining of an engine blade within an aircraft engine extending along a main fluid flow direction from a fluid inlet side to a fluid outlet side. The machining instrument is in the non-angled initial configuration inserted substantially radially through at least one lateral access opening into the aircraft engine, the lateral access opening being arranged downstream of the engine blade. Subsequently, in the angled working configuration of the machining instrument, a tool head inserted into the tool holder is applied to a leading edge of the engine blade. Further preferably, when the system is used, the distal second shaft section is angled relative to the proximal first shaft section during a transition from the initial configuration to the working configuration.

The advantages of the above-described use of a system for in-situ surface treatment of an engine blade correspond to the advantages of the respective embodiment of the system used.

The present invention is described in more detail below with reference to the figures, which show two examples of embodiment of systems for in-situ surface treatment of engine blades. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a side view showing a first example of embodiment of a system for the in-situ surface processing of an engine blade;

FIG. 2 is a partial side view showing a detail of the example of embodiment in FIG. 1 in an initial configuration;

FIG. 3 is a cross-sectional view showing a cross-sectional view through the representation in FIG. 2;

FIG. 4 is a partial side view of the example of embodiment of FIG. 1 in a working configuration;

FIG. 5 is a cross-sectional view of the representation in FIG. 4;

FIG. 6 is a perspective view of a part of the example of embodiment in FIG. 1 with an example of embodiment of a pin-shaped tool;

FIG. 7 is a partial schematic view of part of a second example of embodiment of a system for the in-situ surface processing of an engine blade;

FIG. 8 is a cross-sectional view of the representation in FIG. 7;

FIG. 9 is a schematic view of a surface of a drive shaft that is used in the example of embodiment in FIGS. 7 and 8; and

FIG. 10 is a schematic partially sectional view of an example of embodiment of an aircraft engine.

### DESCRIPTION OF PREFERRED EMBODIMENTS

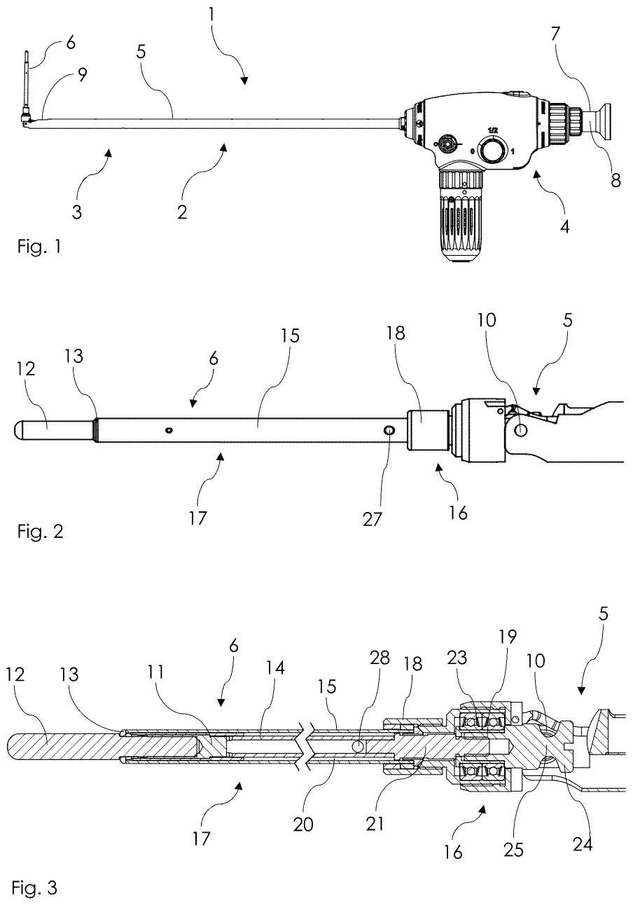

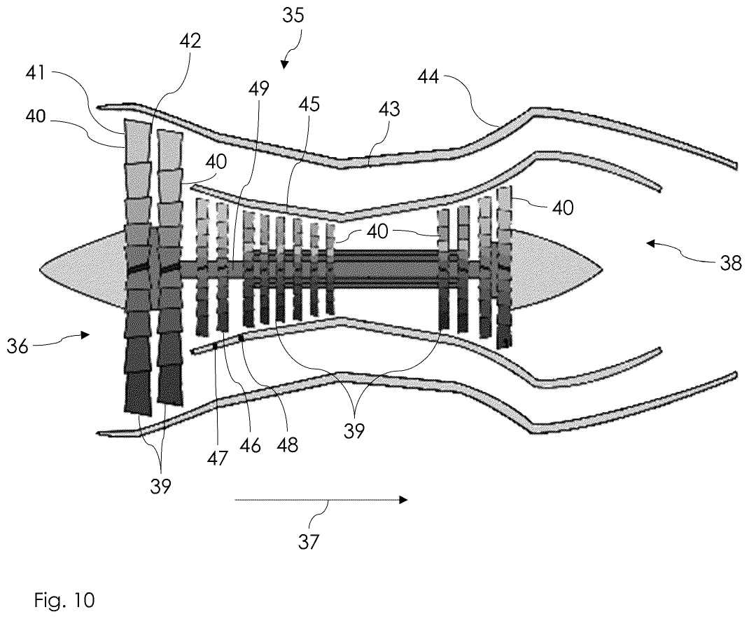

Referring to the drawings, FIG. 1 shows a first example of embodiment of a system 1 for the in-situ surface processing of an engine blade. The system 1 comprises a processing instrument 2 with a tubular shaft 3 that can be angled, and a manually held manipulation device 4. The endoscopic processing instrument 2 can be inserted into an aircraft engine through a lateral access port in a non-angled initial configuration, as will be explained in more detail below with reference to FIG. 10. In a working configuration that is shown in FIG. 1, the tubular shaft 3 is angled. In order to be able to angle the shaft 3, it is divided into a proximal first shaft section 5 and a distal second shaft section 6. To change from the initial configuration to the working configuration and back, the second shaft section 6 is pivoted or angled relative to the first shaft section 5.

The endoscopic processing instrument 2 has an observation instrument 7 which is integrated into the processing instrument 2. Of the processing instrument 7, which is sufficiently known to the person skilled in the art from the prior art, only an eyepiece 8 and an exit opening 9 are shown in FIG. 1, in which a mirror is arranged, which enables a user looking through the eyepiece 8 to look in the direction of the second shaft section 6 when this is arranged at an angle to the first shaft section 5.

FIGS. 2 and 3 show a detail of the example of embodiment shown in FIG. 1, comprising the second shaft section 6 and part of the first shaft section 5. Here, the second shaft section 6 is in the non-angled initial configuration with respect to the first shaft section 5. In FIG. 3, which shows a cross-sectional view through the representation of FIG. 2, the second shaft section 6 is only partially shown, as indicated by the double jagged line, in order to be able to show clearly the essential elements of the processing instrument 2.

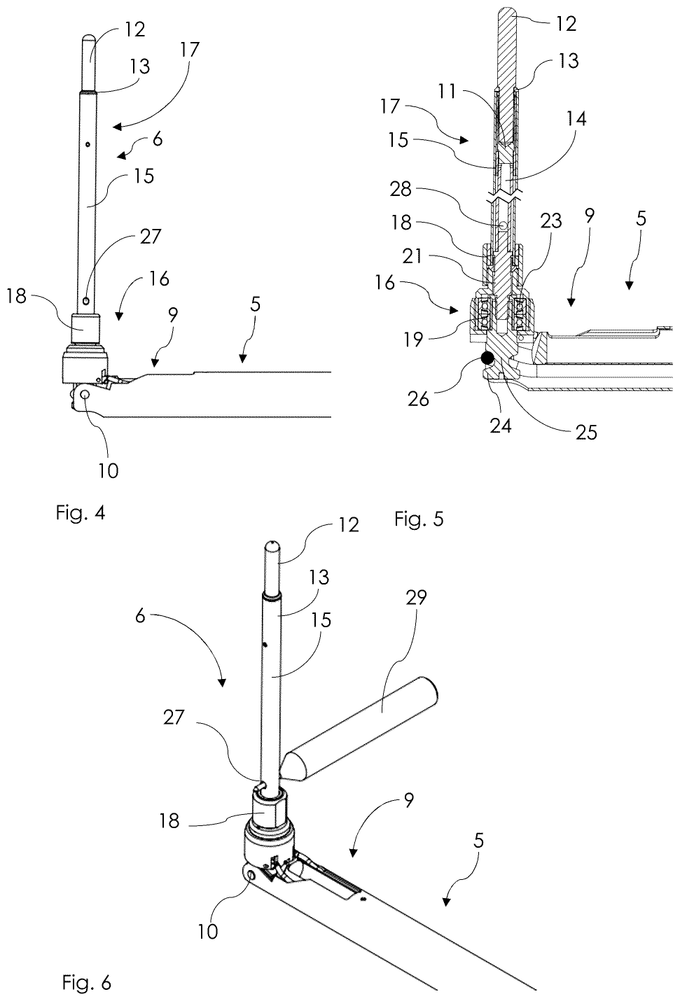

As can be seen in FIGS. 2 and 3, the second shaft section 6 is pivotably arranged on the first shaft section 5 by way of an articulation 10. For example, the second shaft section 6 can be pivoted through 90°+/−10° relative to the first shaft section 5 for transition from the initial configurations shown in FIGS. 2 and 3 to the working configurations shown in FIGS. 1, 4 and 5.

As can clearly be seen, in particular in FIG. 3, the second shaft section 6 has a tool holder 11 into which various tool heads 12 can be inserted. The tool heads 12 can take the form, for example, of milling, grinding or polishing attachments that protrude from the distal or free end 13 of the second shaft section 6. The tool head 2 can be used to process the surface of an engine blade.

Furthermore, a shaft 14 is arranged within the second shaft section 6, with which the tool holder 11 and thus a tool head 12 inserted in the latter can be rotationally driven. For this purpose, the shaft 14 is mounted in the second shaft section 6 such that it can rotate.

The tool holder 11 and the drive shaft 14 are surrounded by a sleeve 15, which could also be referred to as a sheath or tube. The sleeve 15 does not rotate when the drive shaft 14 is rotationally driven and thus prevents components of the engine blade that are not intended to be processed from being damaged by the rotating drive shaft 14 and the tool holders that also rotate. Conversely, the sleeve 15 also protects the drive shaft 14 and the tool holder 11 from damage.

The second shaft section 6 can be further divided into a coupling section 16 and an extension section 17. The coupling section 16 serves to connect the extension section 17 to the processing instrument 2 in a releasable manner. By using the coupling section 16, extension sections 17 of different lengths or, as will be shown in more detail below, with or without a bend in the extension section 17, can be used. This enables the processing of engine blades at different depths, or of engine blades where the access port is located at different distances from the engine blade.

The coupling section 16 is divided into two parts, and comprises an outboard coupling 18 and an inboard coupling 19. The inboard coupling 19 is only shown in the cross-sectional views in FIGS. 3 and 5.

The outboard coupling 18 is configured such that it can be connected to the sleeve 15 in a torque-proof manner. For this purpose, a thread is formed on an inner wall of the outboard coupling 18, in which a corresponding mating thread on the sleeve 15 engages. The threads are not explicitly shown in FIGS. 3 and 5. Since the connection of the outboard coupling 18 and the sleeve 15 is torque-proof, the sleeve 15 cannot be rotated relative to the outboard coupling 18 in the connected state without, at least partially, releasing the sleeve 15 from the outboard coupling.

The inboard coupling 19 is configured accordingly, and also has a thread to which the part of the drive shaft 14 guided in the extension section 17, which can also be referred to as the distal part 20 of the drive shaft 14, is connected in a torque-proof manner by means of a coupling element 21. The torque-proof connection between the distal part 20 of the drive shaft 14 and the inboard coupling 19 is also provided by a thread formed on an internal surface of the inboard coupling 19. A corresponding mating thread is formed on the coupling element 21 of the distal part 20 of the drive shaft 14. These threads are also not shown in FIGS. 3 and 5.

By virtue of the torque-proof connection between the inboard coupling 19 and the distal part 20 of the drive shaft 14, the inboard coupling 19 forms a part of the drive shaft 14, which can also be referred to as the proximal part 22 of the drive shaft 14. If the inboard coupling 19 is caused to rotate by a corresponding drive, this correspondingly causes the distal part 20 of the drive shaft 14 to rotate, which rotation is transmitted to a tool head 12 via the tool holder 11. The inboard coupling 19 is correspondingly arranged in the second shaft section 6 such that it can rotate, wherein a ball bearing 23 is provided for this purpose in the example of embodiment shown in FIGS. 1 to 5.

The inboard coupling 19 has a belt guide pulley 25 at its proximal end 24; this can only be seen in FIGS. 3 and 5, and also forms the proximal end of the drive shaft 14. As can be seen in FIG. 5, a drive belt 26 is tensioned over the belt guide pulley 25 in the angled working configuration, by means of which the drive shaft 14 is driven, that is to say, set in rotation. The drive belt 26 is guided within the first shaft section 5 to the manipulation device 4, in which an electric motor (not shown) is arranged to drive the drive belt 26. The electric motor arranged in the manipulation device 4 can also be referred to as the drive unit.

As can be clearly seen from a comparison of FIGS. 3 and 5, the belt guide pulley 25 is configured such that when the second shaft section 6 is tilted from the initial configuration in FIG. 3 into the working configuration in FIG. 5, the drive belt 26 is tensioned around the belt guide pulley 25. This advantageously ensures that in the initial configuration no power transmission is possible between the drive belt 26 and the drive shaft 14, and thus the tool head 12. Thus, an inadvertent activation of the motor in the manipulation device 4 before the endoscopic processing instrument 2 is in the working configuration cannot cause the tool head 12 to rotate and thus lead to damage.

In order to connect the extension section 17 of the second shaft section 6 to the coupling section 16, that is to say, to screw the thread formed on the distal part 20 of the drive shaft 14 onto the thread formed on the inboard coupling 19, and also to screw the sleeve 15 onto the outboard coupling 18, in the example of embodiment shown in FIGS. 1 to 6, a through-passage hole 27, 28 is formed in both the sleeve 15 and the distal part 20 of the drive shaft 14. A pin-shaped tool 29 is inserted through the through-passage holes 27, 28, as shown in FIG. 6.

The pin-shaped tool 29 is used to fix the alignment, that is to say, the relative orientation or relative rotation of the distal part 20 of the drive shaft 14 and the sleeve 15 relative to each other, so that the extension section 17 can be connected to the coupling section 16 via the two couplings 18, 19. Also, to release the connection between the extension section 17 and the coupling section 16, the pin-shaped tool 29 is again guided through the two through-passage holes 27, 28. The tool 29 itself can then also be used as a lever with which the appropriate screwing movements are carried out. To operate the endoscopic processing instrument 2, the pin-shaped tool 29 is removed from the through-passage holes 27, 28.

Moreover, as can be seen in FIG. 6, in the present example of embodiment, a change of the extension section 17, that is to say, both the connection of an extension section 27 to the coupling section 16, and the disconnection of the extension section 17 from the latter, is performed when the processing instrument 2 is in the working configuration, that is to say, when the second shaft section 6 is angled with respect to the first shaft section 5. This is because, in the working position, the drive belt 26 driving the drive shaft 14 is tensioned around the belt guide pulley 25 formed at the proximal end 24 of the drive shaft 14, and thus prevents the inboard coupling 19 from rotating when the extension section 17 is screwed in. In this way, a connection can be easily made between the extension section 17 and the coupling section 16.

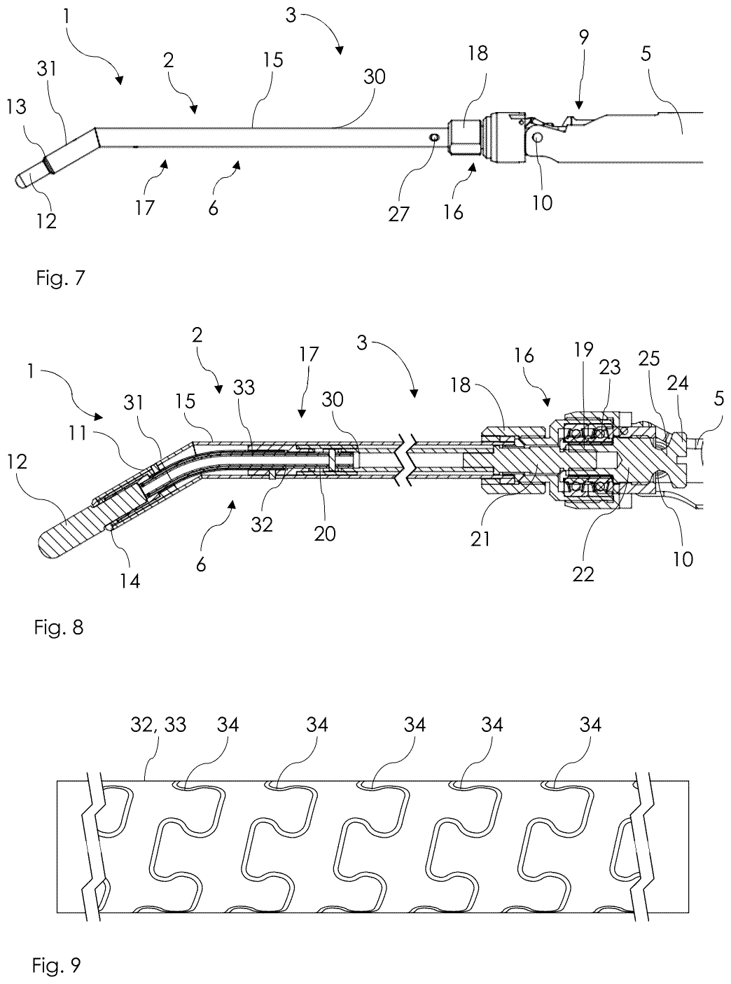

With reference to FIGS. 7 and 8, a second example of embodiment of a system 1 for in-situ surface processing is described below. This system 1 and the processing instrument 2 used therein largely correspond to the example of embodiment that has already been described with reference to FIGS. 1 to 6. Therefore, only those differences in which the second example of embodiment deviates from the first example of embodiment are described below. Identical or the same elements as in the first example of embodiment are marked with the same reference symbol.

The second example of embodiment differs from the first example of embodiment in the configuration of the extension section 17 of the second shaft section 6, which is not straight, but rather has a bend with which surfaces of an engine blade that are otherwise difficult to reach can be processed.

In the form of embodiment, the second shaft section 6, that is, in particular the extension section 17, is divided into a proximal first sub-section 30 and a distal second sub-section 31. The second sub-section 31 extends at a fixed angle, for example 15°, with respect to the first sub-section 30. Thus, the tool holder 11, and a tool head 12 inserted in the latter, are also inclined with respect to the direction of extension of the first sub-section 30. The angle at which the second sub-section 31 is inclined to the first sub-section 30 is opposite to the angle at which the first sub-section 30 is inclined to the first shaft section 5 when the manipulation device 4 is in the working configuration. For example, in the working configuration, the first sub-section 30 can be inclined at 90° with respect to the first shaft section 5, while the second sub-section 31 is inclined at 75° with respect to the first shaft section 5.

In order still to be able to drive the tool holder 11 and a tool head 12 inserted in the latter, the drive shaft 14 and in particular the distal part 20 of the drive shaft 14 extending through the extension section 17 in the example of embodiment is configured to be bendable. This is necessary to allow the rotating drive shaft 14 to extend over the bend formed between the first and second sub-sections 30, 31.

In the example of embodiment shown in FIGS. 7 and 8, the distal part 20 of the drive shaft 14 is formed by two tubular transmission elements 32, 33, which are inserted into each other, and are of slitted design in an overlapping section. In the example of embodiment shown in FIGS. 7 and 8, the section in which the tubular transmission elements 32, 33 are slitted in an overlapping manner corresponds to the entire length of the transmission elements 32, 33.

The exact slit pattern cannot be seen in FIG. 8, but is shown in FIG. 9, which is a plan view onto one of the tubular transmission elements 32, 33. FIG. 9 clearly shows that the slits 34 spiral around the transmission elements 32, 33 a number of times. However, the slits 34 do not follow a straight line, but are formed in a meandering manner. This shape of the slits, which can be produced as laser slits, for example, has proved to be particularly advantageous, as it enables low-loss transmission of the torque.

In FIGS. 7 and 8, the first shaft section 5 is only partially shown. The endoscopic processing instrument 2 is not shown in any further detail. In this respect, reference is made to the representations contained in the preceding figures, which in this respect show a design that is identical to the second example of embodiment.

Finally, FIG. 10 shows an example of an aircraft engine 35 in the form of a turbofan engine. The representation in FIG. 10 takes the form of a cross-sectional view through the engine 35.

The engine 35 comprises a fluid inlet side 36 through which, in operation, air flows into the engine along a main fluid flow direction 37 and passes through the engine to a fluid outlet side 38. The engine 35 shown in FIG. 10 has a plurality of compressor and turbine stages 39, only a few of which are marked with reference symbols in FIG. 10 in the interests of clarity. Each of the compressor and turbine stages 39 is made up of a large number of engine blades or rotor blades 40, of which, again, only a few are marked with reference symbols in the interests of clarity. Each of the engine blades has a leading edge 41 and a trailing edge 42, wherein for only one engine blade 40 in FIG. 10 the leading edge 41 and the trailing edge 42 are provided with reference symbols. The leading edge 41 is the flow edge of the engine blade 40 facing towards the fluid inlet side 36 of the engine 35. Correspondingly, the flow edge of the engine blade 40 facing towards the fluid outlet side 38 is designated as the trailing edge 42.

FIG. 10 further shows the engine nacelle 43, which forms the casing 44 of the engine. Some of the engine blades 40 is also arranged in an additional compressor casing 45. For example, in order to be able to carry out surface processing on the engine blade 46 designated by the reference symbol 46, an access port 47 is formed in the compressor casing 45, which is arranged in front of the engine blade 46 in the flow direction 37, and through which a known endoscopic processing instrument can be inserted.

By virtue of the complex geometry of the engine blades 46, however, it is necessary to be able to process them on their rear face as well. For this purpose, an access port 48 is used, which is formed downstream of the engine blade 46, and is actually provided for purposes of processing the engine blades 40, 46 of the subsequent compressor or turbine stage 39. Through this access port 48, a processing instrument 2 can be introduced into the engine 35 radially towards the central axis 49, in accordance with the previously described examples of embodiment. By virtue of the elongated second shaft section 6, this processing instrument 2 can be used to machine the engine blade 46 and also the other engine blades from the rearward face in the main flow direction 37. This enables a complete and thorough repair of the flow edges 41, 42 of the engine blades 40, 46.

The aircraft engine 35 shown in FIG. 10 has further access ports 47, 48 which, however, are not shown in the figure so as not to overcomplicate the latter. Possible access ports through the engine nacelle 43 or the outer casing of the engine 35 are also not shown, as the latter can also be opened up so to access the compressor casing 45.

While specific embodiments of the invention have been shown and described in detail to illustrate the application of the principles of the invention, it will be understood that the invention may be embodied otherwise without departing from such principles.

### LIST OF REFERENCE SYMBOLS

1 System
2 Endoscopic processing instrument
3 Shaft
4 Manipulation device
5 Proximal first shaft section
6 Distal second shaft section
7 Observation instrument
8 Eyepiece
9 Exit opening with mirror
10 Articulation
11 Tool holder
12 Tool head
13 Distal or free end of the second shaft section
14 Drive shaft
15 Sleeve
16 Coupling section
17 Extension section
18 Outboard coupling
19 Inboard coupling
20 Distal part of the drive shaft
21 Coupling element
22 Proximal part of the drive shaft
23 Ball bearing
24 Proximal end of the inboard coupling/drive shaft
25 Belt guide pulley
26 Drive belt
27 Through-passage hole in the sleeve
28 Through-passage hole in the distal part of the drive shaft
29 Pin-shaped tool
30 Proximal first sub-section
31 Distal second sub-section
32 Tubular transmission element
33 Tubular transmission element
34 Slits
35 Aircraft engine
36 Fluid inlet side
37 Main fluid flow direction
38 Fluid outlet side
39 Compressor or turbine stages
40 Engine blade
41 Leading edge
42 Trailing edge
43 Engine nacelle
44 Casing
45 Compressor casing
46 Engine blade
47 Access port, upstream
48 Access port, downstream
49 Central axis

What is claimed is:

1. A system for in-situ surface processing of an engine blade within an aircraft engine extending along a main fluid flow direction from a fluid inlet side to a fluid outlet side, the system comprising an endoscopic processing instrument, the endoscopic processing instrument comprising:
a tubular shaft that can be angled, wherein the processing instrument is configured to be inserted in a non-angled initial configuration essentially radially through at least one lateral access port into the aircraft engine, which lateral access port is located downstream of the engine blade; and
a rotatably driven tool holder for a tool head for surface processing, the rotatably driven tool holder being at a distal end of the shaft, wherein in an angled working configuration the processing instrument is configured to place the tool head, inserted into the tool holder, against a flow edge of the engine blade.

2. A system according to claim 1, wherein the processing instrument further comprises an observation instrument integrated into the processing instrument.

3. A system according to claim 1, further comprising an endoscopic observation instrument that is separate from the processing instrument, wherein the observation instrument is configured to be inserted essentially radially through another lateral access port of the aircraft engine, wherein the other lateral access port is arranged upstream of the engine blade.

4. A system according to claim 1, wherein the shaft of the processing instrument has a proximal first shaft section and a distal second shaft section, which second shaft section can be angled from the initial configuration into the working configuration with respect to the first shaft section, wherein the tool head, inserted into the tool holder, extends from a free distal end of the second shaft section, and a drive shaft for the tool holder is rotatably mounted within the second shaft section, with which drive shaft a tool head inserted into the tool holder can be driven.

5. A system according to claim 4, wherein the second shaft section has a length which is at least five times as large as an outer diameter of the first shaft section.

6. A system according to claim 4, wherein the drive shaft is configured to be driven by a drive belt extending along the first shaft section, which drive belt in the working configuration runs around a proximal end of the drive shaft serving as a belt guide pulley.

7. A system according to claim 6, wherein the drive belt is tensioned by angling of the second shaft section with respect to the first shaft section from the initial configuration to the working configuration.

8. A system according to claim 4, wherein the second shaft section has at least one coupling section and one extension section, wherein the coupling section adjoins the first shaft section, and the extension section is releasably connected to the coupling section, wherein the extension section comprises a distal part of the drive shaft, together with a sleeve surrounding the distal part of the drive shaft.

9. A system according to claim 8, wherein the coupling section has an outboard coupling for a torque-proof connection of the coupling section to the sleeve, and an inboard coupling for a torque-proof connection of the coupling section to the distal part of the drive shaft, wherein the inboard coupling can be rotated relative to the outboard coupling so as to drive the distal section of the drive shaft, and wherein the connection between the outboard coupling and the sleeve, and also the connection between the inboard coupling and the distal part of the drive shaft, are releasable.

10. A system according to claim 8, wherein the drive shaft is configured to be driven by a drive belt extending along the first shaft section, which drive belt in the working configuration runs around a proximal end of the drive shaft serving as a belt guide pulley, wherein the inboard coupling forms the proximal end of the drive shaft.

11. A system according to claim 8, wherein the system is configured temporarily to fix a relative orientation between the sleeve and the distal part of the drive shaft for purposes of making the connection between the extension section and the coupling section (18), and for purposes of releasing the same.

12. A system according to claim 11, wherein for fixing the relative orientation of the sleeve and the distal part of the drive shaft, the sleeve and the distal part of the drive shaft each have a through-passage hole which can be aligned relative to one another by means of a pin-shaped tool.

13. A system according to claim 4, wherein the second shaft section has a proximal first sub-section and a distal second sub-section, wherein the second sub-section runs at a fixed angle with respect to the first sub-section.

14. A system according to claim 13, wherein the second sub-section runs at an angle opposite to the first sub-section with respect to the direction in which the second shaft section can be angled with respect to the first shaft section.

15. A system according to claim 13, wherein the drive shaft extends flexibly and/or in an articulated manner from the first sub-section into the second sub-section.

16. A system according to claim 15, wherein the drive shaft comprises at least one tubular transmission element, wherein the at least one tubular transmission element is slitted in at least one section.

17. A system according to claim 15, wherein the drive shaft comprises at least two tubular transmission elements which are inserted into one another, wherein each of the transmission elements is slitted in at least one overlapping section.

18. A system according to claim 16, wherein the at least one tubular transmission element is slitted in the at least one section by means of a meandering multiple spiral-shaped peripheral laser cut.

19. A system according to claim 13, wherein the second shaft section has at least one coupling section and one extension section, wherein the coupling section adjoins the first shaft section, and the extension section is releasably connected to the coupling section, wherein the extension section comprises a distal part of the drive shaft, together with a sleeve surrounding the distal part of the drive shaft, wherein the first sub-section and the second sub-section form the extension section.

20. A system according to claim 1, wherein the processing instrument further comprises a manipulation device configured to be held manually by an operator, wherein a drive unit is integrated in the manipulation device, or can be connected to the manipulation device, wherein the shaft is releasably coupled to the manipulation device, or is non-releasably connected to the manipulation device.

21. A system according to claim 1, further comprising a set of different tool heads that can be replaceably coupled with the tool holder as required.

22. A process of using a system for in-situ surface processing of an engine blade within an aircraft engine extending along a main fluid flow direction from a fluid inlet side to a fluid outlet side, the process comprising the steps of:
providing the system so as to comprise an endoscopic processing instrument, the endoscopic processing instrument comprising: a tubular shaft that can be angled, wherein the processing instrument is configured to be inserted in a non-angled initial configuration essentially radially through at least one lateral access port into the aircraft engine; and a rotatably driven tool holder for a tool head for surface processing, the rotatably driven tool holder being at a distal end of the shaft, wherein in an angled working configuration the processing instrument is configured to place the tool head, inserted into the tool holder, against a flow edge of the engine blade;
inserting the processing instrument in the non-angled initial configuration substantially radially through the at least one lateral access port into the aircraft engine, wherein the lateral access port is arranged downstream of the engine blade;
and subsequent to the step of inserting, with the processing instrument in the angled working configuration, placing a tool head that is inserted into the tool holder, against a flow edge of the engine blade.

23. A process according to claim 22, wherein the shaft of the processing instrument has a proximal first shaft section and a distal second shaft section, which second shaft section can be angled from the initial configuration into the working configuration with respect to the first shaft section, wherein the tool head, inserted into the tool holder, extends from a free distal end of the second shaft section, and a drive shaft for the tool holder is rotatably mounted within the second shaft section, with which drive shaft a tool head inserted into the tool holder can be driven and wherein the second shaft section is angled relative to the first shaft section during a transition from the initial configuration to the working configuration.
